(19) United States
(12) Patent Application Publication
(10) Pub. No.: US 2023/0245206 A1
(43) Pub. Date: Aug. 3, 2023

(54) TIME SENSITIVE ITEM-TO-ITEM RECOMMENDATION SYSTEM AND METHOD

(71) Applicant: salesforce.com, inc., San Francisco, CA (US)

(72) Inventors: Joshua Correa, Arlington, MA (US); Alexander Kushkuley, Easthampton, MA (US)

(21) Appl. No.: 17/589,657

(22) Filed: Jan. 31, 2022

(51) Int. Cl. G06Q 30/06; G06Q 30/02; G06F 11/34

(52) U.S. Cl. CPC G06Q 30/0631; G06Q 30/0201; G06F 11/3438; G06F 11/3476

(57) ABSTRACT

A method and system for item-to-item recommendation that collects a set of visitors having interacted with at least one product of a website containing a collection of products, creates a click matrix including a collection of per-product visitor sets based on the set of visitors, change a weight value for at least one of the set of visitors, construct a co-view matrix based on determining a product of each of the changed set of visitors for each pair of products of the collection of products, determine a per-product ordered ranking of product pairs based on the co-view matrix, and select a recommended product based on a user selected product and the per-product ordered ranking of product pairs.

A method and a system for providing item-to-item recommendations for visitors on an e-commerce website based on a visitor interaction with a product offered for sale on the e-commerce website.

### BACKGROUND

Typically, item-item collaborative filtering, or item-based, or item-to-item, is a form of collaborative filtering that recommender systems employ based on a determined similarity between items calculated using visitor's ratings of those items. Early collaborative filtering systems were based on rating similarity between users (known as user-user collaborative filtering) and had several problems, namely, systems performed poorly when they had many items but comparatively few ratings, computing similarities between all pairs of users was expensive, user profiles changed quickly and the entire system model had to be recomputed.

Item-item models attempted to resolve these problems in systems that have more users than items where item-item models use rating distributions per item, not per user. With more users than items, each item tends to have more ratings than each user, so an item's average rating usually doesn't change quickly. This leads to more stable rating distributions in the model, so the model doesn't have to be rebuilt as often. When users consume and then rate an item, that item's similar items are picked from the existing system model and added to the user's recommendations.

However, there exists a need for a time-dependent item-to-item recommendation system that takes into account an event log simulation with a built-in exponential decay based on time sensitivity, reflecting a recency of events, and a separation of product rank computation from computation of a system state.

### BRIEF SUMMARY

It should be appreciated that this Summary is provided to introduce a selection of concepts in a simplified form that are further described below in the Detailed Description. This Summary is not intended to be used to limit the scope of the claimed subject matter.

In one embodiment disclosed herein a method provides an item-to-item recommendation including providing a processor in communication with a memory and a storage device, the storage device configured to store processor instructions for communication to the memory and configured to be executed by the processor, collecting, by the processor, a set of visitors (C) that have interacted with at least one product (p) of a website containing a collection of products (P), creating, by the processor, a click matrix (S) including a collection (Ω) of per-product visitor sets based on the set of visitors (C), wherein the click matrix (S) defines a system state at a first time.

The embodiment of the method further includes changing, by the processor, a weight value for at least one of the set of visitors (C), by at least one of: reducing the weight value of the set of visitors (C) by a discount rate (α); increasing the weight value of the set of visitors (C) by an event type increment weight (w_{E}) weight; increasing the weight value set of visitors (C) by a co-view increment weight (w_{CV}); and uniformly reducing at predetermined equal length time intervals (τ) the weight value of the set of visitors (C) by a constant (click-rate independent) rank reduction rate (β).

The embodiment of the method further includes constructing, by the processor, a co-view matrix ( [symbol] ) based on determining a product (μ) of each of the changed set of visitors (C) for each pair of products (p, q) of the collection of products (P), determining, by the processor, a per-product ordered ranking of product pairs based on the co-view matrix ( [symbol] ), and selecting, by the processor, a recommended product (q) based on a user selected product (p) and the per-product ordered ranking of product pairs.

In another embodiment disclosed herein a method provides an item-to-item recommendation including collecting a per-product (p) set of visitors (C) that have interacted with at least one product (p) of a website containing a collection of products (P), the collection (Ω) of per-product visitor sets comprises a click matrix (S) defining a system state at a first time, assigning an initial weight function (wC) to each visitor record of the set of visitors (C) in the collection (Ω) of per-product set of visitors, changing the weight function (wC) for at least one of the set of visitors (C), constructing a co-view matrix ( [symbol] ) based on determining a product (μ) of each of the changed set of visitors (C) for each pair of products (p, q) of the collection of products (P), determining, by the processor, a per-product ordered ranking of product pairs based on the co-view matrix ( [symbol] ), and selecting, by the processor, a recommended product (q) based on a user selected product (p) and the per-product ordered ranking of product pairs.

In another embodiment disclosed herein, a system includes an e-commerce website server configured to present a collection of products (P) for purchase to visitors at an e-commerce web site, a monitoring server configured to: collect a set of visitors (C) that have interacted with at least one product (p) of the e-commerce website containing the collection of products (P); create a click matrix (S) including a collection (Ω) of per-product visitor sets based on the set of visitors (C).

The embodiment of the e-commerce website server is further configured to change a weight value for at least one of the set of visitors (C), by at least one of: reducing the weight value of the set of visitors (C) by a discount rate (α); increasing the weight value of the set of visitors (C) by an event type increment weight (w_{E}) weight; increasing the weight value set of visitors (C) by a co-view increment weight (w_{CV}); and uniformly reducing the weight value of the set of visitors (C) at predetermined equal length time intervals (τ) by a constant (click-rate independent) rank reduction rate (β).

The embodiment of the e-commerce website server is further configured to construct a co-view matrix ( [symbol] ) based on determining a product (μ) of each of the changed set of visitors (C) for each pair of products (p, q) of the collection of products (P), and determining, by the processor, a per-product ordered ranking of product pairs based on the co-view matrix ( [symbol] ).

The embodiment of the system further includes a recommendation server configured to select and transmit a recommended product (q) to a visitor on the e-commerce website based on a visitor selected product (p) and the per-product ordered ranking of product pairs.

### BRIEF DESCRIPTION OF THE SEVERAL VIEWS OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

The embodiments will be better understood from the following detailed description with reference to the drawings, which are not necessarily drawing to scale and in which:

FIG. 1 illustrates an embodiment of a method the provides an item-to-item recommendation;

FIG. 2 illustrates another embodiment of a method the provides an item-to-item recommendation;

FIG. 3 illustrates another embodiment of a system that includes an e-commerce web site server, a monitoring server and a recommendation server configured to provide an item-to-item recommendation;

FIG. 4 illustrates an exemplary computer system suitable for implementing implementations of the presently disclosed subject matter; and

FIG. 5 illustrates an exemplary computer network arrangement suitable for implementing implementations of the presently disclosed subject matter.

### DETAILED DESCRIPTION

### Introduction

The embodiments described herein are directed toward a method and system for item-to-item recommendation that collects per-product sets of visitors having interacted with at least one product of a website containing a collection of products, that creates and maintains a click matrix including a collection of per-product visitor sets that contain weight values for each of the visitors that interacted with a given product.

The embodiments described herein introduce a time-sensitive recommendation algorithm and a recommender system architecture based on the recommendation algorithm. One embodiment described herein of the algorithm may be described as an event log simulation with a built-in time-based exponential decay. The system embodiment features may include time sensitivity, where a system state may transparently reflect a “recency” of events, and a complete separation of product rank computation from computation of the system state—practically any distance-like function may be plugged in as a similarity function (μ).

### DEFINITIONS

Event types for any given item or product, (p), a set of relevant event types, (E), may be as follows: 1) item checkout event type; 2) an item added to cart event type; 3) an item recommendation click event type; 4) an item view event type; and, 5) an item recommendation view event type.

A positive real number, (i.e., a weight w), may be associated with each event type in such a way that, for example, an item checkout weight may have a greater weight than an item added to cart weight. Accordingly, the relevant event types, (E), may have a ranked weight by the event type, e.g., 1) the item checkout event type weight>2) the item added to cart event type weight, >3) the item recommendation click event type weight >4) the item view event type weight,>5) the item recommendation view event type weight. Thus, a system parameter weight function may be defined as:

w_{E}:E→ [symbol] (1)

defined on the set of event types E.

### Visitor Sets

For any given item or product p, a per product time dependent fuzzy set C of visitors, i, (or clickers), that have interacted with the product p and a time dependent weight function w_{C} are defined as:

C={i₁, i₂, . . . } (2)

w_{C}: C→ [symbol] (3)

As will be seen below the weight cᵢ=w_{C}(i) of a visitor/clicker i depends on the click-event type and time. Viewing w_{C} as a time dependent function defined on the set of all visitors [symbol] so that

w_{C}(i)≠0 (4)

if and only if

i∈C∈ [symbol] (5)

Denote a collection of all visitor sets, (one for each product p), by Ω. The cardinality of Ω is less than or equal to the cardinality of the set of currently monitored products P,

|Ω|≤|P|. (6)

To simplify, one may assume, however, that P,

|Ω|=|P|, (7)

i.e., one may assume that every site item p has at least one visitor i.

### Relevant Time Slices and Weight Reduction Rates

Three system parameter time-slices are considered:
a time period T that makes idle, (or non-visited), product significantly less relevant, e.g., T=3 days, that is T=72 hours;
a time interval τ for periodic rank discount updates, e.g., a quarter of an hour τ=0.25 hours; and
a session duration parameter σ, e.g., σ=2τ, roughly estimated as an average time length of a visitor i session.

Given that (P) is the set of all (currently) monitored products (p), let (N) be a number of relevant events (E) that happened during the time interval (τ). Assuming that average product click-rate being defined as

r=N/|P| (8)

will hold during time (T) define a per-product rank reduction rate α as

$$α = exp ( - \frac{log ( 2 ) τ}{rT} ) . \qquad ( 9 )$$

Note, that that per-product weight reduction rate a depends on click rate r observed in a particular time interval (τ).

An additional embodiment may also denote a constant (click-rate independent) rank reduction rate (β), (also characterized as an “idle” reduction rate), as

$$β = exp ( - \frac{log ( 2 ) τ}{T} ) . \qquad ( 10 )$$

An additional embodiment may also require that an item (p) should loose half of its rank if it was idle while the list it belongs to was updated an m-number of times. This reduction may be achieved by using a reduction rate (ρ), defined as

$$ρ = exp ( - \frac{log ( 2 )}{m} ) \qquad ( 11 )$$

For example, if m=10 then ρ≈0.93

Alternatively, given an item ρ∈P, one can compute a per-item reduction rate αₚ as follows: if an item (p) was visited (Nₚ) times during time period (T) then

$${α}_{p} = exp ( - \frac{log ( 2 ) τ}{N p T} ) . \qquad ( 12 )$$

### Click Matrix

The collection (Ω) of all per-product visitor sets may be viewed as a (sparse)

|Ω|× [symbol] (13)

time dependent click-matrix (S). This click matrix (S) may essentially constitute the system state. Weights of the click matrix (S) are periodically reduced in a manner similar to an exponential decay process which is parametrized by a relevant time horizon and current per-product click-rates.

### Co-view Matrix

The click matrix (S) is used periodically to construct a co-view matrix [symbol] of co-view weights computed for each pair of the set of visitors that correspond to a pair of products of the collection of products (P). This allows to determine a ranking of product pairs (p, q) based on the co-view matrix ( [symbol] ), and to select a per-product recommendation lists based on a user selected product (p) and mentioned above per-product co-view weights.

This (usually sparse) co-view matrix ( [symbol] ) is defined as follows: fix, (as a system parameter), a positive valued function:

μ:Ω×Ω→ [symbol] (14)

For the pair of items

p,q∈P (15)

let

Cₚ, C_{q}∈Ω (16)

denote corresponding (fuzzy) visitor sets. Then p, q entry in [symbol] is denoted as

μ(Cₚ, C_{q}). (17)

The function μ (p, q) must have some properties of a distance. An example may be a fuzzy cardinality of a fuzzy intersection of (Cₚ) and (C_{q}).

### Product Affinity Ranking

A typical product recommender deployed on an on-line retailer web-site works by computing a product-to-product similarity (affinity) ranks. In other words, given a product

p₀∈P (18)

a recommender will order the elements of a subset

P={pi₁,p₂, . . . ,}⊂P,p_{0∉P} (19)

in such a way that (p₁) is most similar product to (p₀, p₂) is next most similar product to p₀ and so on. Four method embodiments of product similarity ranking are presented below. A choice of one of these methods may be a system parameter.

### Method 1—Deriving Affinity Ranks from Matrix C

Product affinity ranks may be obtained by ordering row elements of matrix (C).

### Method 2—Matrix Factorization

Use singular value decomposition (SVD) of matrix S to compute affinity ranks.

### Method 3—Rank Mixture

The results of Method 1 and Method 2 may be combined by applying various rank mixture rules.

### Method 4—“Same Session” Similarity Boost

Higher attribute weights may be given to co-view events that occur within the time duration of an average visitor session.

### Event Processing

A collection of per product fuzzy sets C, (see equation (2)), is maintained and updated based on the event log of the website. For example, suppose a visitor i caused an event from the set of predefined events, e∈E, associated with a product (p). Then the visitor set C≡Cp that corresponds to (p) may be updated as follows:

### Algorithm 1

All current elements in (C) are reduced by a global discount rate (α), in other words for all j∈C an update is made:

w_{C}(j):=αw_{C}(j). (20)

Alternatively, the weights could be reduced by a pre-product discount rate:

w_{C}(j):=aₚw_{C}(j). (21)

The current visitor weight is then increased by an update value:

w_{C}(i):=w_{C}(i)+w_{E}(e). (22)

At time intervals of length τ the weights of all fuzzy set elements for all products are uniformly reduced as follows:

w_{C}(i):=βw_{C}(i),i∈C,C∈Ω (23)

The simulation proceeds as follows: at regular intervals, (e.g., every hour), the collection (Ω) is updated by simulating all the events e in the latest event log of the website. The resulting collection of visitor sets, (a current system state), is recorded and reused on the next simulation run. A current product affinity matrix (C) is computed as described in the co-view matrix ( [symbol] ), above.

### Algorithm 2

In an alternative embodiment, while executing Algorithm 1, above, record the set Σ of item pairs that were visited within the session duration period of time, (σ).

The set of item pairs Σ produced by Algorithm 2 may be used to modify an existing similarity function (μ) by increasing its value on same session visited item pairs.

The co-view matrix ( [symbol] ) depends on a “distance” function μ as defined in the Co-View Matrix ( [symbol] ), above, where by varying similarity function μ, one may compute multiple co-view matrices [symbol] (μ) from the same system state.

The various parameters described above can be used for system tuning. As future research possibilities one might consider either developing machine learning models for parameter estimation or bandit-like architectures that can be utilized for continuous parameter adjustment.

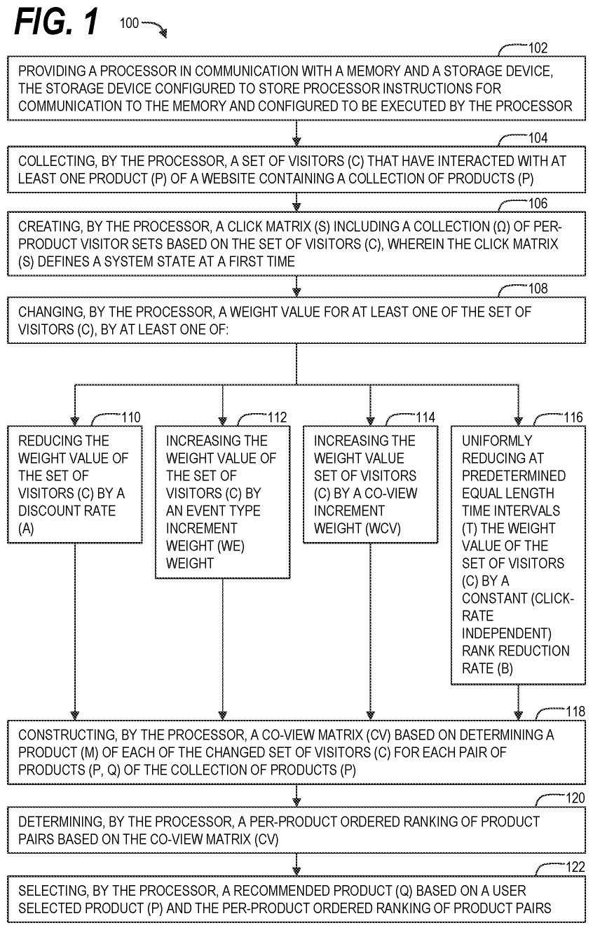

FIG. 1 illustrates [1] an embodiment of a method 100 that provides an item-to-item recommendation that includes providing 102 a processor in communication with a memory and a storage device, the storage device configured to store processor instructions for communication to the memory and configured to be executed by the processor, and collecting 104, by the processor, a set of visitors (C) that have interacted with at least one product (p) of a website containing a collection of products (P). The method further provides creating 106, by the processor, a click matrix (S) including a collection (Ω) of per-product visitor sets based on the set of visitors (C), wherein the click matrix (S) defines a system state at a first time, and changing 108, by the processor, a weight value for at least one of the set of visitors (C), by at least one of: reducing 110 the weight value of the set of visitors (C) by a discount rate (α); increasing 112 the weight value of the set of visitors (C) by an event type increment weight (w_{E}) weight; increasing 114 the weight value set of visitors (C) by a co-view increment weight (w_{CV}); and uniformly reducing 116 predetermined equal length time intervals (τ) the weight value of the set of visitors (C) by a constant (click-rate independent) rank reduction rate (β).

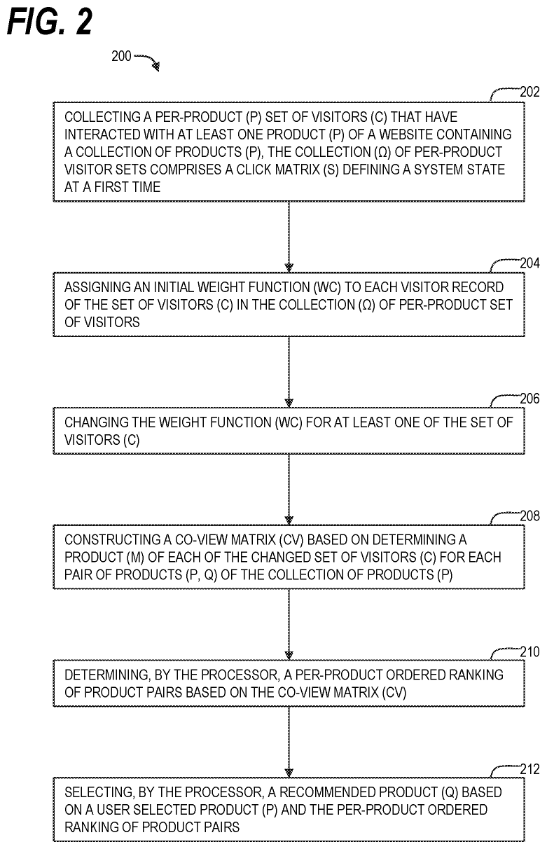

The embodiment of the method further provides constructing 118, by the processor, a co-view matrix ( [symbol] ) based on determining a product (μ) of each of the changed set of visitors (C) for each pair of products (p, q) of the collection of products (P), determining 120, by the processor, a per-product ordered ranking of product pairs based on the co-view matrix ( [symbol] ), and selecting 122, by the processor, a recommended product (q) based on a user selected product (p) and the per-product ordered ranking of product pairs.

[2] The embodiment of the method further provides where the set of visitors (C) includes a time dependent fuzzy set of visitors (S), and where the click matrix C includes rows of per-product visitor sets, where each visitor entry in the per-product visitor set accounts for a unique visitor identifier, a timestamp value corresponding to a visit time to the product, and an event type identifier.

[3] The embodiment of the method further provides where reducing the weight value of the set of visitors (C) by the discount rate (α) reduces the set of all products, and where the discount rate (α) comprises a global discount rate (α_{G}) dependent upon: a periodic rank discount update time interval (τ); an average product click-rate (r) defined as a number of relevant events (N) over the given set of products (P); and an idle time period (T).

[4] The embodiment of the method further provides where the global discount rate (α_{G}) is defined as

$$α G = exp ( - \frac{log ( 2 ) τ}{rT} ) .$$

[5] The embodiment of the method further provides where reducing the weight value of the set of visitors (C) by the discount rate (α) reduces the set of all products, and where the discount rate (α) comprises a per-product discount rate (αₚ) dependent upon: a periodic rank discount update time interval (τ); a total number of times an item was visited (p); and a time period (T).

[6] The embodiment of the method further provides where the per-product discount rate (αₚ) is defined as

$${α}_{p} = exp ( - \frac{log ( 2 ) τ}{N T} ) ,$$

where (N) is defined as a number of relevant events (E) over the time period (T).

[7] The embodiment of the method further provides where the event type increment weight (w_{E}) is dependent upon on a user-initiated event being one of: an item checkout; an item added to a shopping cart; an item recommendation click; an item view; and an item recommendation view.

[8] The embodiment of the method further provides where each of the user-initiated events are given a corresponding event type increment weight (w_{E}) based on a proximity of the user-initiated event to a completed transaction.

[9] The embodiment of the method further provides where the co-view increment weight (w_{CV}) is dependent upon: a first user event visiting a first item during a user session period; a second user event visiting a second item during the user session period; and a same user being identified with the first and second user event.

[10] The embodiment of the method further provides where the first and second user event being selected from one of the following group of events: an item checkout; an item added to a shopping cart; an item recommendation click; an item view; and an item recommendation view.

[11] The embodiment of the method further provides where uniformly reducing the weight value of the set of visitors (C) by the constant (click-rate independent) rank reduction rate (β) reduces the set of all products, and wherein the constant (click-rate independent) rank reduction rate (β) is dependent upon: a periodic rank discount update time interval (τ); and an time period (T).

[12] The embodiment of the method further provides where the constant (click-rate independent) rank reduction rate (β) is defined as

$$β = exp ( - \frac{log ( 2 ) τ}{T} ) .$$

[13] The embodiment of the method further provides updating, by the processor at a second time, the updated set of visitors (C) that have interacted with at least one product (p) of the website, and the click matrix (S) including the collection (Ω) of per-product visitor sets based on the updated set of visitors (C), wherein the updated click matrix (S) defines the system state at the second time.

[14] The embodiment of the method further provides changing, by the processor, a weight value for at least one of the updated set of visitors (C), by at least one of: reducing the weight value of the updated set of visitors (C) by the discount rate (α); increasing the updated set of visitors (C) by the event type increment weight (w_{E}) weight; increasing the updated set of visitors (C) by the co-view increment weight (w_{CV}); and uniformly reducing at predetermined equal length time intervals (τ), the updated set of visitors (C) by a constant (click-rate independent) rank reduction rate (β); constructing, by the processor, an updated co-view matrix ( [symbol] ) based on determining a product (μ) of each of the changed updated set of visitors (C) for each pair of products (p, q) of the collection of products (P); determining, by the processor, a second per-product ordered ranking of product pairs based on the updated co-view matrix ( [symbol] ); and selecting, by the processor, a next recommended product (q′) based on a second user selected product (p′) and the second per-product ordered ranking of product pairs.

[15] The embodiment of the method further provides where the selecting the recommended product (q) based on the user selected product (p) and the per-product ordered ranking of product pair further comprises further selecting the recommended product (q) based on singular value decomposition (SVD) of the click matrix (S).

[16] The embodiment of the method further provides where the selection of the recommended product (q) based on the user selected product (p) further comprises utilizing a rank mixture rule to combine the per-product ordered ranking of product pairs based on the co-view matrix ( [symbol] ) and the singular value decomposition (SVD) of the click matrix (S).

[17] FIG. 2 illustrates another embodiment of a method 200 providing an item-to-item recommendation that includes collecting a 202 per-product (p) set of visitors (C) that have interacted with at least one product (p) of a website containing a collection of products (P), the collection (Ω) of per-product visitor sets comprises a click matrix (S) defining a system state at a first time, assigning 204 an initial weight function (wC) to each visitor record of the set of visitors (C) in the collection (Ω) of per-product set of visitors, and changing 206 the weight function (wC) for at least one of the set of visitors (C).

The embodiment of the method further provides constructing 208 a co-view matrix ( [symbol] ) based on determining a product (μof each of the changed set of visitors (C) for each pair of products (p, q) of the collection of products (P), determining 210, by the processor, a per-product ordered ranking of product pairs based on the co-view matrix ( [symbol] ), and selecting 212, by the processor, a recommended product (q) based on a user selected product (p) and the per-product ordered ranking of product pairs.

[18] The embodiment of the method further provides where changing the weight function (w_{C}) for at least one of the set of visitors (C) comprises changing the weight function based on a time-dependent user-click independent function that includes at least one of: reducing the weight function of the set of visitors (C) by a discount rate (α); increasing the weight function set of visitors (C) by a co-view increment weight (w_{CV}); and uniformly reducing the weight function of the set of visitors (C) at predetermined equal length time intervals (τ) by a constant (click-rate independent) rank reduction rate (β).

[19] The embodiment of the method further provides where changing the weight function (w_{C}) for at least one of the set of visitors (C) further comprises changing the weight function based on a user-click dependent function that includes increasing the weight function of the set of visitors (C) by an event type increment weight (w_{E}) weight.

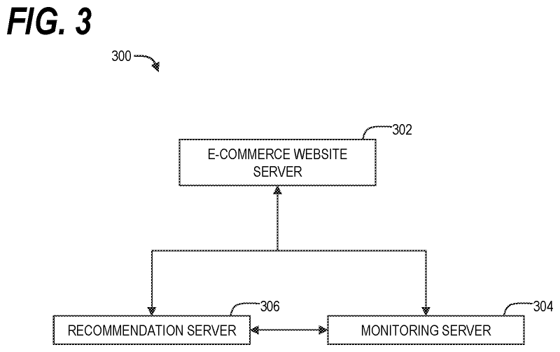

FIG. 3 illustrates another embodiment of a system 300 that includes an e-commerce website server 302 configured to present a collection of products (P) for purchase to visitors at an e-commerce website, a monitoring server 304 in communication with the e-commerce website server 302 and configured to collect a set of visitors (C) that have interacted with at least one product (p) of the e-commerce website containing the collection of products (P), create a click matrix (S) including a collection (Ω) of per-product visitor sets based on the set of visitors (C).

The embodiment of the system further provides the monitoring server changing a weight value for at least one of the set of visitors (C), by at least one of: reducing the weight value of the set of visitors (C) by a discount rate (α); increasing the weight value of the set of visitors (C) by an event type increment weight (w_{E}) weight; increasing the weight value set of visitors (C) by a co-view increment weight (w_{CV}); and uniformly reducing the weight value of the set of visitors (C) at predetermined equal length time intervals (τ) by a constant (click-rate independent) rank reduction rate (β).

The embodiment of the system further provides the monitoring server constructing a co-view matrix ( [symbol] ) based on determining a product (μ) of each of the changed set of visitors (C) for each pair of products (p, q) of the collection of products (P), and determining, by the processor, a per-product ordered ranking of product pairs based on the co-view matrix ( [symbol] ).

The embodiment of the system further includes a recommendation server 306 in communication with the monitoring server 304 and the e-commerce website server 302, the monitoring server 306 configured to select and transmit a recommended product (q) to a visitor on the e-commerce website based on a visitor selected product (p) and the per-product ordered ranking of product pairs.

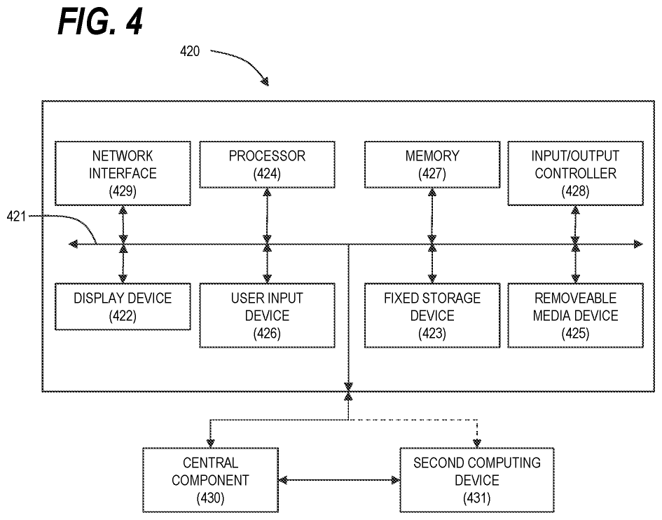

Implementations of the presently disclosed subject matter may be implemented in and used with a variety of component and network architectures. FIG. 4 is an example computer 420 suitable for implementing implementations of the presently disclosed subject matter. As discussed in further detail herein, the computer 420 may be a single computer in a network of multiple computers. As shown in FIG. 4, computer may communicate a central component 430 (e.g., server, cloud server, database, etc.). The central component 430 may communicate with one or more other computers such as the second computer 431. According to this implementation, the information obtained to and/or from a central component 430 may be isolated for each computer such that computer 420 may not share information with computer 431. Alternatively, or in addition, computer 420 may communicate directly with the second computer 431.

The computer (e.g., user computer, enterprise computer, etc.) 420 includes a bus 421 which interconnects major components of the computer 420, such as a central processor 424, a memory 427 (typically RAM, but which may also include ROM, flash RAM, or the like), an input/output controller 428, a user display 422, such as a display or touch screen via a display adapter, a user input interface 426, which may include one or more controllers and associated user input or devices such as a keyboard, mouse, Wi-Fi/cellular radios, touchscreen, microphone/speakers and the like, and may be closely coupled to the I/O controller 428, fixed storage 423, such as a hard drive, flash storage, Fibre Channel network, SAN device, SCSI device, and the like, and a removable media component 425 operative to control and receive an optical disk, flash drive, and the like.

The bus 421 enable data communication between the central processor 24 and the memory 427, which may include read-only memory (ROM) or flash memory (neither shown), and random-access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components.

Applications resident with the computer 420 can be stored on and accessed via a computer readable medium, such as a hard disk drive (e.g., fixed storage 423), an optical drive, floppy disk, or other storage medium 425.

The fixed storage 423 may be integral with the computer 420 or may be separate and accessed through other interfaces. A network interface 429 may provide a direct connection to a remote server via a telephone link, to the Internet via an internet service provider (ISP), or a direct connection to a remote server via a direct network link to the Internet via a POP (point of presence) or other technique. The network interface 429 may provide such connection using wireless techniques, including digital cellular telephone connection, Cellular Digital Packet Data (CDPD) connection, digital satellite data connection or the like. For example, the network interface 429 may enable the computer to communicate with other computers via one or more local, wide-area, or other networks, as shown in FIG. 14.

Many other devices or components (not shown) may be connected in a similar manner (e.g., document scanners, digital cameras and so on). Conversely, all of the components shown in FIG. 4 need not be present to practice the present disclosure. The components can be interconnected in different ways from that shown. The operation of a computer such as that shown in FIG. 4 is readily known in the art and is not discussed in detail in this application. Code to implement the present disclosure can be stored in computer-readable storage media such as one or more of the memory 427, fixed storage 423, removable media 425, or on a remote storage location.

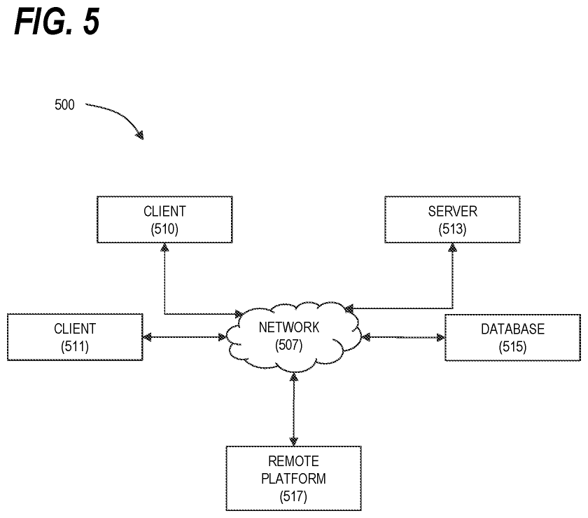

FIG. 5 shows an example network arrangement 500 according to an implementation of the disclosed subject matter. One or more clients 510, 511, such as computers, microcomputers, local computers, smart phones, tablet computing devices, enterprise devices, and the like may connect to other devices via one or more networks 507 (e.g., a power distribution network). The network may be a local network, wide-area network, the Internet, or any other suitable communication network or networks, and may be implemented on any suitable platform including wired and/or wireless networks. The clients may communicate with one or more servers 513 and/or databases 515. The devices may be directly accessible by the client's 510, 511, or one or more other devices may provide intermediary access such as where a server 513 provides access to resources stored in a database 515. The clients 510, 511 also may access remote platforms 517 or services provided by remote platforms 517 such as cloud computing arrangements and services. The remote platform 517 may include one or more servers 513 and/or databases 515. Information from or about a first client may be isolated to that client such that, for example, information about client 510 may not be shared with client 511. Alternatively, information from or about a first client may be anonymized prior to being shared with another client. For example, any client identification information about client 510 may be removed from information provided to client 511 that pertains to client 510.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to generate specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general-purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific arrangements and configurations. However, the illustrative examples provided herein are not intended to be exhaustive or to limit embodiments of the disclosed subject matter to the precise forms disclosed. Many modifications and variations are possible in view of the disclosure provided herein. The embodiments and arrangements were chosen and described in order to explain the principles of embodiments of the disclosed subject matter and their practical applications. Various modifications may be used without departing from the scope or content of the disclosure and claims presented herein.

What is claimed is:

1. A method of providing an item-to-item recommendation, the method comprising:
providing a processor in communication with a memory and a storage device, the storage device configured to store processor instructions for communication to the memory and configured to be executed by the processor;
collecting, by the processor, a set of visitors (C) that have interacted with at least one product (p) of a website containing a collection of products (P);
creating, by the processor, a click matrix (S) including a collection (Ω) of per-product visitor sets based on the set of visitors (C), wherein the click matrix (S) defines a system state at a first time;
changing, by the processor, a weight value for at least one of the set of visitors (C), by at least one of:
reducing the weight value of the set of visitors (C) by a discount rate (α);
increasing the weight value of the set of visitors (C) by an event type increment weight (w_{E}) weight;
increasing the weight value set of visitors (C) by a co-view increment weight (w_{CV}); and
uniformly reducing at predetermined equal length time intervals (τ) the weight value of the set of visitors (C) by a constant (click-rate independent) rank reduction rate (β);
constructing, by the processor, a co-view matrix ( [symbol] ) based on determining a product (μ) of each of the changed set of visitors (C) for each pair of products (p, q) of the collection of products (P);
determining, by the processor, a per-product ordered ranking of product pairs based on the co-view matrix ( [symbol] ); and
selecting, by the processor, a recommended product (q) based on a user selected product (p) and the per-product ordered ranking of product pairs.

2. The method of claim 1, wherein the set of visitors (C) comprises a time dependent fuzzy set of visitors (S), and
wherein the click matrix C comprises rows of per-product visitor sets, where each visitor entry in the per-product visitor set accounts for a unique visitor identifier, a timestamp value corresponding to a visit time to the product, and an event type identifier.

3. The method of claim 1, wherein reducing the weight value of the set of visitors (C) by the discount rate (α) reduces the set of all products, and
wherein the discount rate (α) comprises a global discount rate (α_{G}) dependent upon:
a periodic rank discount update time interval (τ);
an average product click-rate (r) defined as a number of relevant events (N) over the given set of products (P); and
an [idle] time period (T).

4. The method of claim 3, wherein the global discount rate (α_{G}) is defined as
$$α G = exp ( - \frac{log ( 2 ) τ}{rT} ) .$$

5. The method of claim 1, wherein reducing the weight value of the set of visitors (C) by the discount rate (α) reduces the set of all products, and
wherein the discount rate (α) comprises a per-product discount rate (αₚ) dependent upon:
a periodic rank discount update time interval (τ);
a total number of times an item was visited (p); and
a time period (T).

6. The method of claim 5, wherein the per-product discount rate (αₚ) is defined as
$${α}_{p} = exp ( - \frac{log ( 2 ) τ}{N T} ) ,$$
where (N) is defined as a number of relevant events (E) over the time period (T).

7. The method of claim 1, wherein the event type increment weight (w_{E}) is dependent upon on a user-initiated event being one of:
an item checkout;
an item added to a shopping cart;
an item recommendation clicks;
an item view; and
an item recommendation view.

8. The method of claim 7, wherein each of the user-initiated events are given a corresponding event type increment weight (w_{E}) based on a proximity of the user-initiated event to a completed transaction.

9. The method of claim 1, wherein the co-view increment weight (w_{CV}) is dependent upon:
a first user event visiting a first item during a user session period;
a second user event visiting a second item during the user session period; and
a same user being identified with the first and second user event.

10. The method of claim 9, wherein the first and second user event being selected from one of the following group of events:
an item checkout;
an item added to a shopping cart;
an item recommendation click;
an item view; and
an item recommendation view.

11. The method of claim 1, wherein uniformly reducing the weight value of the set of visitors (C) by the constant (click-rate independent) rank reduction rate (β) reduces the set of all products, and
wherein the constant (click-rate independent) rank reduction rate (β) is dependent upon:
a periodic rank discount update time interval (τ); and
a time period (T).

12. The method of claim 11, wherein the constant (click-rate independent) rank reduction rate (β) is defined as
$$β = exp ( - \frac{log ( 2 ) τ}{T} ) .$$

13. The method of claim 1, further comprising:
updating, by the processor at a second time,
the updated set of visitors (C) that have interacted with at least one product (p) of the website, and
the click matrix (S) including the collection (Ω) of per-product visitor sets based on the updated set of visitors (C), wherein the updated click matrix (S) defines the system state at the second time.

14. The method of claim 13, further comprising:
changing, by the processor, a weight value for at least one of the updated set of visitors (C), by at least one of:
reducing the weight value of the updated set of visitors (C) by the discount rate (α),
increasing the updated set of visitors (C) by the event type increment weight (w_{E}) weight;
increasing the updated set of visitors (C) by the co-view increment weight (w_{CV}); and
uniformly reducing at predetermined equal length time intervals (τ), the updated set of visitors (C) by a constant (click-rate independent) rank reduction rate ( [symbol] );
constructing, by the processor, an updated co-view matrix (C) based on determining a product (μ) of each of the changed updated set of visitors (C) for each pair of products (p, q) of the collection of products (P);
determining, by the processor, a second per-product ordered ranking of product pairs based on the updated co-view matrix ( [symbol] ); and
selecting, by the processor, a next recommended product (q′) based on a second user selected product (p′) and the second per-product ordered ranking of product pairs.

15. The method of claim 1, wherein the selecting the recommended product (q) based on the user selected product (p) and the per-product ordered ranking of product pair further comprises further selecting the recommended product (q) based on singular value decomposition (SVD) of the click matrix (S).

16. The method of claim 15, wherein the selection of the recommended product (q) based on the user selected product (p) further comprises utilizing a rank mixture rule to combine the per-product ordered ranking of product pairs based on the co-view matrix ( [symbol] ) and the singular value decomposition (SVD) of the click matrix (S).

17. A method of providing an item-to-item recommendation, the method comprising:
collecting a per-product (p) set of visitors (C) that have interacted with at least one product (p) of a web site containing a collection of products (P), the collection (Ω) of per-product visitor sets comprises a click matrix (S) defining a system state at a first time;
assigning an initial weight function (wC) to each visitor record of the set of visitors (C) in the collection (Ω) of per-product set of visitors;
changing the weight function (wC) for at least one of the set of visitors (C);
constructing a co-view matrix ( [symbol] ) based on determining a product (μ) of each of the changed set of visitors (C) for each pair of products (p, q) of the collection of products (P);
determining, by the processor, a per-product ordered ranking of product pairs based on the co-view matrix ( [symbol] ); and
selecting, by the processor, a recommended product (q) based on a user selected product (p) and the per-product ordered ranking of product pairs.

18. The method of claim 17, wherein changing the weight function (wC) for at least one of the set of visitors (C) comprises changing the weight function based on a time-dependent user-click independent function that includes at least one of:
reducing the weight function of the set of visitors (C) by a discount rate (α);
increasing the weight function set of visitors (C) by a co-view increment weight (w_{CV}); and
uniformly reducing the weight function of the set of visitors (C) at predetermined equal length time intervals (τ) by a constant (click-rate independent) rank reduction rate (β).

19. The method of claim 18, wherein changing the weight function (wC) for at least one of the set of visitors (C) further comprises changing the weight function based on a user-click dependent function that includes increasing the weight function of the set of visitors (C) by an event type increment weight (w_{E}) weight.

20. A system comprising:
an e-commerce website server configured to present a collection of products (P) for purchase to visitors at an e-commerce web site;
a monitoring server configured to:
collect a set of visitors (C) that have interacted with at least one product (p) of the e-commerce web site containing the collection of products (P);
create a click matrix (S) including a collection (Ω) of per-product visitor sets based on the set of visitors (C);
change a weight value for at least one of the set of visitors (C), by at least one of:
reducing the weight value of the set of visitors (C) by a discount rate (α);
increasing the weight value of the set of visitors (C) by an event type increment weight (w_{E}) weight;
increasing the weight value set of visitors (C) by a co-view increment weight (w_{CV}); and
uniformly reducing the weight value of the set of visitors (C) at predetermined equal length time intervals (τ) by a constant (click-rate independent) rank reduction rate (β);
construct a co-view matrix ( [symbol] ) based on determining a product (μ) of each of the changed set of visitors (C) for each pair of products (p, q) of the collection of products (P); and
determining, by the processor, a per-product ordered ranking of product pairs based on the co-view matrix ( [symbol] ); and
a recommendation server configured to select and transmit a recommended product (q) to a visitor on the e-commerce website based on a visitor selected product (p) and the per-product ordered ranking of product pairs.
